(19) United States
(12) Patent Application Publication
(10) Pub. No.: US 2004/0005344 A1
(43) Pub. Date: Jan. 8, 2004

(54) Head lice formulation

(76) Inventors: Debra Munro, Currumbin (AU); John Munro, Currumbin (AU); Kerry Bone, Warwick (AU)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/415,023

(22) PCT Filed: Sep. 19, 2001
(86) PCT No.: PCT/AU01/01177

(30) Foreign Application Priority Data
Oct. 31, 2000 (AU) PR 1153

(51) Int. Cl. A01N 65/00; A01N 25/00

(52) U.S. Cl. 424/405; 424/737; 424/769; 424/776

(57) ABSTRACT

A head lice shampoo contains adhatoda and stemona which together increase the kill rate of lice. The shampoo can be substantially free of pyrtherin.

### FIELD OF THE INVENTION

This invention relates to a chemical composition which can be applied to a person's head to kill head lice and eggs and which does not require pyrethrum, or which requires only low doses of pyrethrum. Specifically, one form of the invention is directed to a head lice formulation which comprises effective amounts of Stemona and Adhatoda.

### BACKGROUND ART

Head lice formulations are known in the art but many have low efficiency, are surprisingly toxic, are expensive to manufacture, have limited shelf life, or the consuming public finds the formulations unsuitable or undesirable.

Traditionally, lice and eggs are removed from a person's hair using a fine tooth comb, but using a fine tooth comb for long or thick hair is extremely difficult, and is not a long term solution.

A known formulation consists of flour, salt and water but the formulation tends to cake and has a rather low efficiency.

Some head lice preparations contain, as the active ingredient, toxic components such as benzine which are progressively being banned. Formic acid has also been used as an active ingredient in a head lice formulation, but formic acid is extremely painful when in contact with scratches or other open wounds. Kerosene has been used as a active ingredient to kill head lice but kerosene is extremely flammable, and is an extreme irritant to skin and eyes.

It is also known to use compositions having a high alcohol content and an emulsifier but these compositions are not well tolerated by most consumers. Garlic and parsley have been used in an anti-lice shampoo for treating hair.

A more extreme known example is to form a gas tight cap around a person's hairline and to fill the gas tight cap with carbon dioxide in an attempt to asphyxiate lice. Quarternary ammonium compounds have been used in lice killing compositions but these are quite toxic.

A more common type of head lice shampoo includes insecticides, a common example being pyrethrum. Unfortunately, pyrethrum is loosing its efficacy because of a build-up in resistance to pyrethrum by lice. Increasing the level of pyrethrum in the composition by up to 5% or more can result in toxic side effects.

It is also known to provide head lice compositions or formulations which contain plant extracts, but many of these formulations require rather high amounts of the plant extracts which can increase cost to manufacture the formulation, and can also lead to difficulties in the manufacture of a stable formulation, for instance the formulation which does not de-emulsify over time.

### OBJECT OF THE INVENTION

The present invention is directed to a composition for treating head lice and which need not require pyrethrum, or need not require the amount of pyrethrum which is conventionally used in treating head lice.

In one form of the invention, it has been surprisingly found that particular combinations of plant extracts can provide improvements to head lice compositions, and there may be a synergistic effect taking place between the plant extracts.

In one form, the invention resides in a composition for treating lice, the composition having, as an ingredient, an effective amount of Stemona and Adhatoda.

The composition may be in the form of a liquid or gel which can be applied to the affected body area (such as the head).

Adhatoda may be obtained from the family acanthaceae is and preferably from adhatoda vasica. It is preferred that the extract is derived from the leaf of the plant adhatoda vasica. The plant is known and the leaf extract is recommended for a variety of ailments such as bronchitis, asthma, fever and jaundice. The leaves and roots are effficacious in coughs, arthritis, diarrhea and dysentery and have a good haemostatic quality. The leaves are anti-inflammatory, analgesic, effective in skin disorders, cardiotonic.

Adhatoda vasica includes the compounds vasicine and vasicinone which both show branchodilatory activity both in in vivo and in vitro. The leaves of the plant contain an essential oil and alkaloids such as vasicine, the N-oxide of vasicine, vasicinone, deoxyvasicine and maiontone.

The amount of adhatoda vasica in the formulation can vary from between 1-30% with a preferable range being between 2-50 mg per 1 ml dose, or an equivalent active dose of 100 mg per 1 ml. The adhatoda vasica is preferably extracted as a dry concentration of 5:1.

The composition comprises Stemona which is preferably a root extract from stemona sessilifolia, commonly known as stemona root. The extract can be obtained by suitable extraction of the root, for instance with alcohol, or an alcohol-containing solution. Stemona root is known to reduce coughing due to tuberculosis or whooping cough. The amount of stemona root in the composition can vary with a typical range being from about 0.1-70%. and preferably between 5%-30%. Typically, an amount of between 20-120 mcl and preferably about 80 mcl is present per 1 ml of the composition, or an equivalent active dose of 80.0 mg per 1 ml.

The composition preferably includes tea tree oil which is an essential oil obtained from the leaves and terminal branches of various tea trees, for instance melaleuca alternifolia. Tea tree oil is known for its germicidal properties. Tea tree oil may be present in a composition from between 0.5-10% and a preferred value is between 5-40 mg and most preferably about 20 mg per ml dose.

The composition may include other components which can assist in the efficacy of the composition in treating lice.

The composition may further include a oil extracted from the plant tagetes. This plant has a long history for use as a beverage and condiment. Leaves have been used as a medicinal tea, and leaves, stems and flowers have been utilised in various ways. A preferred plant is tagetes minuta which is an erect annual herb reaching up to 1-2 m. An extract can be obtained by steam distillation, extraction in hot or boiling water, alcohol extraction or the like. The oil is used in perfumes and as a flavour component in most major food products. The entire aboveground portion of the plant is considered useful and the plant is dried, crushed and various components extracted. Tagetes minuta is rich in compounds including acyclic, monocyclic and bicyclic monoterpenes, sesquiterpenes, flavonolds, thiophenes and aromatics. Antimicrobal and antibacterial activity has been found on the extracts. The oil can be present in the composition from between 0.05-20% and a preferred amount is between 0.5-10 mg and most preferably about 2.5 mg per ml.

The composition may further include an extract from the plant echinacea and preferably from the plant echinacea purpurea. This plant is also known as purple cone flower and its habitat is throughout North America.

The extracts from echinacea purpurea include polysaccharides, at least 13 different types of polyacetylenes, essential oils containing humulene, caryophyllene and its epoxide, germacrene D and methl-p-hydroxycinnamate. The extract can also contain vanillin linolenic acid derivatives, flavenoids, and the alkaloides tussilagine and isotussilagine. Echinacea is known to be an antimicrobal and immunomodulator. Echinacea is used to help the body rid itself of microbial infections and is often effective against both bacterial and viral attacks and may be used in conditions such as boils, septicaemie and similar infections. The echinacea extract may be present in an amount of between 0.1-30% and a preferred amount is between 30-150 mcl and most preferably about 80 mcl per 1 ml dose, or 40.0 mg equivalent active per 1 ml dose.

The composition may include oil of nutmeg which may be an oil obtained from the dried kernels of ripe seeds of nutmeg (myristica fragrans). The oil consists of 60-80% of D-camphene, about 8% of D-pinene, dipentene, D-bomeol, L-turpinol, about 6% geraniol, safrol and about 4% myristicin. The oil is a colourless or pale yellow liquid with a taste of nutmeg, is insoluble in water and soluble in alcohol. The nutmeg oil can be present in an amount of 0.1-10% and a preferred amount is between 5-50 mg and most preferably about 20 mg per ml.

The composition may include one or more plant or seed oil extracts. One preferred oil is from the sesame plant and particularly an extract from the sesame seeds. Sesame oil contains antioxidants sesamin and sesamolin and is a natural synergist. There are three types of sesame seeds being white, black and red or brown. The amount of sesame oil extract in the composition may be between 0.1-30% and a preferred amount is between 20-120 mcl and most preferably about 60 mcl per ml dose.

The composition may include a further oil which may comprise oil of orange or oil or orange flowers. Oil of orange is a volatile oil expressed from fresh peel of ripe fruit of the orange and consists of about 90% D-limonene, citral, decyl aldehyde, methl anthranilate, linaool, and terpineol. The oil is a yellow to deep orange liquid with a characteristic orange taste and odour. The oil is slightly soluble in water, and is soluble in alcohol. Known uses for oil of orange are as a flavour and perfume and formerly as an expectorant. The oil of orange flowers is a volatile oil distilled from fresh orange flowers and consists of limonene, L-linalool, geraniol, 7-18% of linalyl acetate and nerol. The oil is a yellowish fluorescent liquid which becomes brown on exposure to light. The oil is slightly soluble in water and soluble in alcohol. The amount of orange oil can vary from between 0.1-10% of the composition with a preferred amount being between 5-50 mg and most preferably about 25 mg per ml dose.

The composition may include picrasma.

The amount of picrasma in the composition may range from 20-150 mcl per 1 ml dose.

The picrasma may be extracted from the stem wood of picrasma excelsa.

Picrasma has the synonyms Quassia; Quassia Wood; Jamaica Quassia; Picraena excelsa

Picrasma consists of the dried stem-wood of Picrasma excelsa (Sw.) Planch. (Fam. Simarubaceae), a tree growing up to 10 metres in height in the West Indies. Commercial samples of Picrasma are obtained from Jamaica. The branches and trunk are freed of bark, cut in transverse chips and dried.

Picrasma yields 0.2% of bitter principles containing quassin, neo-quassin and a yellow crystalline substance.

B.P.C. (1973), p. 422.

Description:

Macroscopical:

Chips and transverse slices, yellow to pale cream in colour, diffuse porous, false annual rings, easily split longitudinally, tangential surface ridged or rippled. Odourless; taste bitter

Microscopical:

Light yellow-buff powder; vessels lignified, groups of up to 12, minutely border-pitted; xylem fibres up to 1 mm long, moderately thick walls, simple slit-like pits, xylem parenchyma in tangential bands up to 14-15 rows wide; axial parenchyma cells containing prismatic crystals of calcium oxalate 1240,m long.

Medullary rays storied, 2-4 cells wide, some cells containing calcium oxalate prisms; starch grains simple, spherical, occasionally compound, 4-12,m in diameter, occur in cells of the parenchyma and medullary rays.

Total Ash

Total Ash: Not more than 5%.

Acid Insoluble Ash:Not more than 1%.

Foreign Organic Matter:

Not more than 2%.

Water Soluble Extractive:Not less than 4%.

Bitterness:

Complies with the Test for Bitterness of the B.P.C. (1973),

The composition may include various emulsifiers and thickening agents and solubilisers. These can include alcohol such as cetostearyl alcohol, and polysorbate. A preferred polysorbate is polysorbate 80 which is a complex mixture of polyoxyethylene ethers of mixed partial oleac esters of sorbitol anhydrides. Polysorbate 80 is an amber coloured viscous liquid which is very soluble in water and alcohol. Polysorbate 80 is used as an emulsifying agent in the preparation of pharmaceuticals. Xanthan gum can also be used. Xanthan gum is a high molecular weight polysaccharide which is used as a stabiliser for emulsions and suspensions. It has numerous areas of applications covering a broad spectrum and range from the food industry to oil recovery. The emulsifiers, thickening agents and the like can be present in a suitable amount in a composition, this amount typically being between 0.1-10%.

The composition may further include water to provide a desirable thickness and flowability to the composition.

### DETAILED DESCRIPTION

In an embodiment, a hair rinse composition was formulated as follows:

### EXAMPLE 1

### Lice Blaster Formulation According to an Embodiment of the Invention

| AMT PER | | | APPROVED |
|---|---|---|---|
| 1 ML | EQUIV. ACTIVE | | HERB NAME OR |
| DOSE | PER 1 ML DOSE | COMMON NAME | FULL AAN |
| *20 mg | 100 mg | Adhatoda ext dry | Adhatoda vasica |
| | | conc 5:1 | |
| 80 mcL | 80 mg | Stemona Root | Stemona |
| | | | sessillifolia |
| 80 mcL | 40 mg | Echinacea | Echinacea |
| | | purpurea | purpurea |
| 60 mcL | n/a | Sesame Oil | Sesamum |
| | | | indicum |
| 80.0 mcL | | Quassia | Picrasma excelsa |
| 25 mg | n/a | Orange Oil | Orange Oil BP93 |
| 20 mg | 20 mg | Tea Tree Oil | Malaleuca Oil |
| | | | TGA 92 |
| 20 mg | n/a | Cetostearyl | Celostearyl |
| | | Alcohol | Alcohol BP93 |
| 20 mg | n/a | Polysorbate 80 | Polysorbate 80 |
| | | | BP 88 |
| 20 mg | n/a | Nutmeg Oil | Myristica fragrans |
| 6 mg | n/a | Xanthan Gum | Xanthan Gum |
| | | | USP22 |
| 2.5 mg | n/a | Tagetes Oil | Tagetes minuta |
| 566.5 mcL | n/a | Process Water | Water-Purified |
| | | | BP93 |

Adhatoda ext dry conc 5:1 contains 20-40% Maltodextrin and was extracted in 45% E:W.
The sesame oil acts as a natural synergist.

### EXAMPLE 2

### Lice Blaster Formulation According to a Further Emb diment of the Invention

| AMT PER | | | APPROVED |
|---|---|---|---|
| 1 ML | EQUIV. ACTIVE | | HERB NAME OR |
| DOSE | PER 1 ML DOSE | COMMON NAME | FULL AAN |
| *40 mg | 200 mg | Adhatoda ext dry | Adhatoda vasica |
| | | conc 5:1 | |
| 120 mcL | 120 mg | Stemona Root | Stemona |
| | | | sessillifolia |
| 80 mcL | 40 mg | Echinacea | Echinacea |
| | | purpurea | purpurea |
| 60 mcL | n/a | Sesame Oil | Sesamum |
| | | | indicum |
| 25 mg | n/a | Orange Oil | Orange Oil BP93 |
| 20 mg | 20 mg | Tea Tree Oil | Malaleuca Oil |
| | | | TGA 92 |
| 40 mg | n/a | Cetostearyl | Celostearyl |
| | | Alcohol | Alcohol BP93 |
| 20 mg | n/a | Polysorbate 80 | Polysorbate 80 |
| | | | BP 88 |
| 20 mg | n/a | Nutmeg Oil | Myristica fragrans |
| 6 mg | n/a | Xanthan Gum | Xanthan Gum |
| | | | USP22 |
| 2.5 mg | n/a | Tagetes Oil | Tagetes minuta |
| 566.5 mcL | n/a | Process Water | Water-Purified |
| | | | BP93 |

Adhatoda ext dry conc 5:1 contains 20-40% Maltodextrin and was extracted in 45% E:W.

The hair rinse had a creamy yellow colour and an odour which was sharp and of tea tree. The composition was a flowable liquid which could be applied to a person's hair. Five patients were tested with the composition described above. The post-first treatment combings showed 80% of the lice killed, 20% of the lice immobilised and 0% of lice which were alive. The composition seems 100% effective in killing or immobilising lice. In practice, a second treatment should be made approximately 7 days after the first treatment to kill any lice which hatched from eggs.

Exposure Method

1. Lice were selected in batches of 5 and assigned with several hairs to petri dishes. An attempt was made to have a mixture of adults and nymphs in each dish. For each of stemona, adhatoda and stemona plus adhatoda 1 replicate was done.

2. Immediately prior to use the mixed test agent was placed on a clean plastic surface.

3. Within 1 minute lice were picked up on hairs by a pair of jewellers forceps and dipped into the test compound so that all surfaces were immersed. This was done under observation with a dissecting microscope.

4. Dipped lice were immediately transferred on the hairs to their petri dish, and under a dissecting microscope, lice were cleared of any thick compound adherent to sides of body and junctions between legs.

5. The dishes were held at room temperature at 25° C.

Observations

1. At set times after exposure the lice were observed under the dissecting microscope for activity. Key observation times were 10 min, 20 min, 1 hr, 1.5 hr, 2 hr, 3 hr.

2. If status was uncertain the dish was opened and the lice stimulated using jewellers forceps.

3. Head lice usually follow a sequence of signs of toxicity progressing from least to worse: incoordination of movements of limbs but able to progress in walking, unusual movements of body (arching, twisting), incoordinated walking, cessation of walking, loss of righting reflex, stationary except for movement of appendages, no movement except for peristalsis, no movement and cessation of peristalsis.

4. Lice were classified into active=behaving normally by walking or responding as expected to touch from forceps; immobile=not walking, or slow walking in an uncoordinated way, or body twisted, and if no movement at all, gut peristalsis present; dead=no movement of appendages and no peristalsis of gut when observed for 1 minute.

3.5 Analysis

Efficacy of Test Agent was Assessed by:

1. the number of lice that were immobilised at the observation times as a proportion of the total lice exposed to the test agent. Immobilised lice could be alive and unable to walk, or dead.

2. the number of lice that were dead at the observation times as a proportion of the total lice exposed to the test agent.

4. Results

The effect of stemona plus adhatoda on immobilising head lice was greater than the effect of either product alone (Table 1, FIG. 1). To obtain the combined result for each test product, the duplicate results were added and percent lice immobilised calculated on the total lice.

TABLE 1
Effect of stemona and adhatoda at 20% concentrations in
immobilising head lice. Values given are percent of lice not mobile.
FFC = the control which is a generic brand family conditioner.

| | | 10 | 20 | 40 | 1 | 1.5 | 2 | 3 |
|---|---|---|---|---|---|---|---|---|
| Agent | Replicate | min | min | min | h | h | h | h |
| Adhatoda | Combined | 70% | 70% | 30% | 50% | 50% | 40% | 40% |
| 20% | | | | | | | | |
| Stemona | Combined | 80% | 50% | 70% | 90% | 100% | 100% | 100% |
| 20% | | | | | | | | |
| Stemona | Combined | 100% | 100% | 100% | 100% | 100% | 100% | 100% |
| 20% plus | | | | | | | | |
| adhatoda | | | | | | | | |
| 20% | | | | | | | | |
| FFC | | 25% | 25% | 25% | 25% | 25% | 25% | 25% |

* Combined - two experiments were carried out and the results averaged.

[image]

If death is used as an end point, the combination of adhatoda plus stemona is more effective at killing lice than either product alone (Table 2, FIG. 2).

TABLE 2
Killing effect of stemona and adhatoda at 20% concentrations on head lice.
Values given are percent of lice killed. FFC = generic brand conditioner

| | | 10 | 20 | 40 | 1 | 1.5 | 2 | 3 |
|---|---|---|---|---|---|---|---|---|
| Aaent | Replicate | min | min | min | h | h | h | h |
| Adhatoda | Combined | 0% | 10% | 10% | 30% | 30% | 30% | 40% |
| 20% | | | | | | | | |
| Stemona | Combined | 0% | 0% | 0% | 20% | 30% | 40% | 40% |
| 20% | | | | | | | | |
| Stemona | Combined | 70% | 70% | 70% | 70% | 70% | 70% | 100% |
| 20% plus | | | | | | | | |
| adhatoda | | | | | | | | |
| 20% | | | | | | | | |
| FFC | | 0% | 0% | 0% | 0% | 0% | 25% | 25% |

* Combined - two experiments were carried out and the results averaged.

[image]

Discussion

Immobilisation of Lice

The combination of stemona (20%) plus adhatoda (20%) had a greater effect than either of the separate products with 100% immobilisation at 10 minutes and at other observation times.

Killing of Lice

Death of lice is defined as complete cessation of all movement of limbs plus cessation of peristalsis of intestine. The combined adhatoda and stemona killed more lice and in a shorter period of time than either product alone (Table 2. FIG. 2). At most observation times the killing rate of the combination was greater than the sum of the killing rate of stemona and adhatoda separately, suggesting a synergistic effect. This supports the hypothesis that each compound may act through a different mechanism. Both immobilisation and death as end points gave results which agreed demonstrating that the combination of stemona and adhatoda was more effective than either product alone.

Conclusion

The combination of stemona (20% v/v) with adhatoda (20% w/v) is more effective at immobilising and killing head lice than either product alone. The combination of the two products is additive and has a synergistic effect when death of head lice is taken as the end point.

COMPARITIVE EXAMPLE 1

[image]

The above example illustrates the effectiveness of the formulation according to an embodiment of the invention (Lice Blaster) compared with the control FFC which is a generic brand home shampoo and a known pyrethrum shampoo. The formulation (Lice Blaster) provides an imediate knockdown effect which is not found with the pyrethrum formulation.

It should be appreciated that various other changes and modifications can be made to the embodiment described without departing from the spirit and scope of the invention.

1. A lice treating composition which comprises adhatoda and stemona.

2. The composition of claim 1 which comprises between 5-30% adhatoda and between 5-30% stemona.

3. The composition of claim 2, comprising about 20% adhatoda and about 20% stemona.

4. A head lice treating shampoo comprising adhatoda and stemona.

5. The shampoo of claim 4 which comprises between 5-30% adhatoda and between 5-30% stemona.

6. The shampoo of claim 5 comprising about 20% adhatoda and about 20% stemona.

7. The shampoo of claim 6 comprising echinacea purpurea.

8. The shampoo of claim 7, comprising tea tree oil.

9. The shampoo of claim 8, comprising sesame oil.

10. A method for treating lice which comprises contacting the lice with a composition which comprises adhatoda and stemona.
